(19) United States
(12) Patent Application Publication
(10) Pub. No.: US 2025/0297483 A1
(43) Pub. Date: Sep. 25, 2025

(54) SELF-ALIGNING SEAM KIT

(71) Applicant: Reuben R. Yoder, Middlefield, OH (US)

(72) Inventor: Reuben R. Yoder, Middlefield, OH (US)

(21) Appl. No.: 18/961,024

(22) Filed: Nov. 26, 2024

Related U.S. Application Data
(60) Provisional application No. 63/569,300, filed on Mar. 25, 2024.

(51) Int. Cl. E04F 13/08; B32B 7/12; B32B 27/08; B32B 27/36

(52) U.S. Cl. CPC E04F 13/0814; B32B 7/12; B32B 27/08; B32B 27/365; B32B 2369/00

(57) ABSTRACT

A structure of two sections of particle board each having a top surface respectively, constructed of a laminate sheet of a material such as plastic or polycarbonate affixed to the top surface of the two sections. The two sections each having an end portion mounted to the free ends of the two sections.

### CROSS-REFERENCE TO RELATED APPLICATIONS

This application claims the benefit of U.S. Provisional Patent Application Ser. No. 63/569,300 filed on Mar. 25, 2024, and U.S. Provisional Patent Application Ser. No. 63/632,309 filed on Apr. 10, 2024, both of which are incorporated by reference in their entireties herein.

### TECHNICAL FIELD

The present invention relates generally to insulated sheathing systems for use in building construction designed to provide moisture permeable panels that protect from bulk water, air and heat transfer. More particularly, the invention relates to sheathing systems comprising structural panels having liquid barriers, an insulating layer, and a sealant, which seals the seams between adjoining panels and the method of installing the system.

### BACKGROUND

Wall and roof panel construction systems of residential or commercial buildings do not typically provide simple, efficient, and safe means of installation. Most often in these systems, extra steps must typically be added to the installation process to prevent liquid moisture, air, and heat from passing through the seam between adjoining panels.

Constructing a wall or table with a weather barrier requires not only that panels be attached to framing members, but also a house or home wrap can be unrolled and spread over the walls. The home or house wrap is attached to the sheathing panels with staples or button cap nails and fenestration openings for windows or doors must be cut out of the wrap and the flaps from these openings folded back and stapled down. While it is important that the barrier layer shed bulk water, it should allow for the escape of water vapor. Moreover, since house wraps are only fastened at limited points, pockets or voids form between the sheathing and home or house wrap. If the barrier were to trap water vapor in a wall panel, the build-up of moisture could lead to rot or mold growth.

Furthermore, small gaps along the edges of adjoining panels typically remain after installation assembly. These thermal gaps within the building envelope allow undesirable thermal energy entry and escape through the walls. Although home or house wrap can provide some protection, breaks or tears in the house wrap often form during installation or construction.

Example embodiments of assembling and dissembling table systems and components are described herein. One or more of the example embodiments can provide for table components that are easier to assemble, disassemble, and reassemble than tables decks.

One or more of the example embodiments provide for disassembling an assembled table, moving the disassembled table from a first location to a second location and subsequently reassembling the table at the first location, the second location, or a third location. Disassembly of the table can occur for storage of the components during an expected time-frame when the table will not be used (such as winter time) or for some other.

In one respect, one or more example embodiments can be arranged as a table comprising: (i) a first section comprising a first (FS), a second SS, a third TS, and a fourth FS, wherein the first FS is removably attached to the second SS and if desired to the third TS and the fourth FS. Wherein the second SS is removably attached to the first FS and to the third TS and possibly the fourth FS. and one or more joist assemblies are removably attached to and within the table.

### SUMMARY OF THE INVENTION

A structure of two sections of particle board each having a top surface respectively, constructed of a laminate sheet of a material such as plastic or polycarbonate affixed to the top surface of the two sections. The two sections each having an end portion mounted to the free ends of the two sections.

A structure of two sections of particle board each having a top surface respectively, constructed of a laminate sheet of a material such as plastic or polycarbonate affixed to the top surface of the two sections; The two sections each having an end portion removably mounted to the free ends of the two sections of particle board. One section of particle board has a plastic or polycarbonate end portions having a first side which includes a first wall portion that rests against the free end of the section of the first particle board. Another of the sections of particle board has a plastic or polycarbonate end portion having a first side which includes a second wall portion that rests against the free end of the another of the sections of the second particle board.

### BRIEF DESCRIPTION OF THE DRAWINGS

The structure, operation, and advantages of the present invention will become further apparent upon consideration of the following description taken in conjunction with the accompanying figures (Figures). The figures are intended to be illustrative, not limiting.

Certain elements in some of the figures may be omitted, or illustrated not-to-scale, for illustrative clarity. The cross-sectional views may be in the form of slices, or near-sighted cross-sectional views, omitting certain background lines which would otherwise be visible in a true cross-sectional view, for illustrative clarity.

Often, similar elements may be referred to by similar numbers in various figures (Figures) of the drawing, in which case typically the last two significant digits may be the same, the most significant digit being the number of the drawing figure (Figure).

FIG. 1 is an exploded side view of two portions of particle board each having a laminate bonded thereon.

FIG. 2 is a three dimensional view of the two portions of particle board each having a laminate bonded thereon and interconnected to each other.

FIG. 3 is a two dimensional view, partially In cross section, of the two portions of particle board each having a laminate bonded thereon and interconnected to each other.

### DETAILED DESCRIPTION OF THE PREFERRED EMBODIMENT

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader and should not in any way be interpreted as limiting.

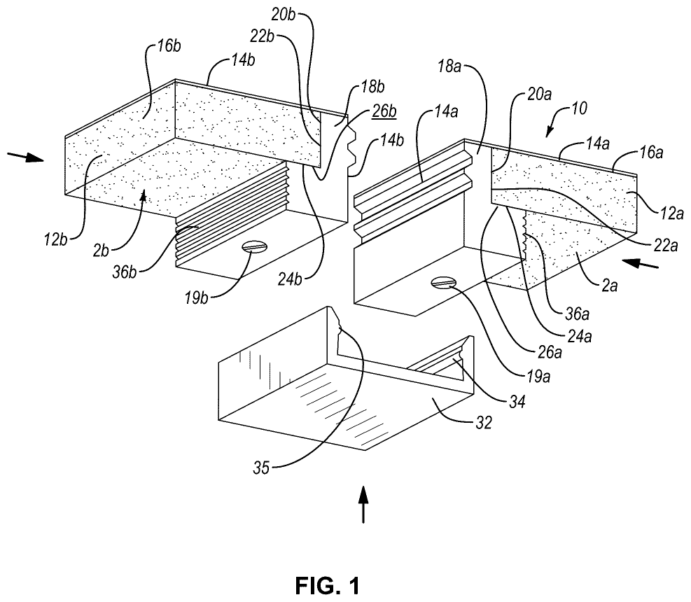

Referring to FIG. 1, there is illustrated a table 10 constructed of two sections of particle board 12a and 12b each having a top surface 14a and 14b, respectively, constructed of a laminate sheet of a material such as plastic or polycarbonate affixed to the top surface 16a and 16b, respectively, of the two sections 12a and 12b by means such as glue or PVC.

In general, the present invention relates to two sections of particle board 12a and 12b also known as chipboard manufactured by mixing particles or flakes of wood or jute-stick together with a resin and forming the mixture into a sheet. The raw material is fed into a disc chipper with between four and sixteen radially arranged blades. The chips from disk chippers are more uniform in shape and size than from other types of wood chippers. The particles are then dried, and any oversize or undersized particles are screened out. Resin is then sprayed as a fine mist onto the particles. Several types of resins are used in the process. Amino-formaldehyde based resins are the best performing based on cost and ease of use. Urea melamine resins offer water resistance with more melamine offering higher resistance. It is typically used in external applications, with the coloured resin darkening the panel. To further enhance the panel properties, resorcinol resins can be mixed with phenolic resins, but that is more often used with marine plywood applications.

Panel production involves other chemicals including wax, dyes, wetting agents and release agents, to aid processing or make the final product resistant to water, fire or insects.

After the particles pass through a mist of resin sufficient to coat all surfaces, they are layered into a continuous carpet. This ‘carpet’ is then separated into discrete, rectangular ‘blankets’ which will be compacted in a cold press.

A scale weighs the flakes, and they are distributed by rotating rakes. In graded-density particleboard, the flakes are spread by an air jet that throws finer particles further than coarse ones. Two such jets, reversed, allow the particles to build up from fine to coarse and back to fine.

The formed sheets are cold-compressed to reduce thickness and make them easier to transport. Later, they are compressed again, under pressures between 2 and 3 megapascals (290 and 440 psi) and temperatures between 140 and 220° C. (284 and 428° F.) to set and harden the glue. The entire process is controlled to ensure the correct size, density and consistency of the board.

The boards are then cooled, trimmed and sanded. They can then be sold as raw board or surface improved through the addition of a wood veneer or laminate surface.

The particle board core has a top surface 14a and 14b, a bottom surface, and at least four sides or edges. Located or affixed on the top surface 14a and 14b is an overlay layer 16a and 16b of a laminate which can be a thermoplastic of at least one thermoplastic material.

Generally, any thermoplastic material, combinations thereof, alloys thereof, or mixtures of two or more thermoplastics can be used to form the laminate which include, but are not limited to, vinyl containing thermo plastics such as polyvinyl chloride, polyvinyl acetate, polyvinyl alcohol, and other vinyl and vinylidene resins and copolymers thereof; polyethylenes such as low density polyethylenes and high density polyethylenes and copolymers thereof; styrenes such as ABS, SAN, and polystyrenes and copolymers thereof; polypropylene and copolymers thereof. saturated and unsaturated polyesters; acrylics; polyamides such as nylon containing types; engineering plastics such as acetyl, polycarbonate, polyimide, polysulfone, and polyphenylene oxide and sulfide resins and the like. The thermoplastic polymers set forth in Kirk Othmer incorporated in their entirety by reference herein) can also be used as long as the resulting board has sufficient strength for its intended purpose.

Preferably, the thermoplastic material used to form the laminate is a rigid polyvinyl chloride but semi-rigid or flexible polyvinyl chloride may also be used. The flexibility of the thermoplastic material can be imparted by using at least one liquid or solid plasticizer which is preferably present in an amount of less than about 20 phr, and more preferably, less than 1 phr. A typical rigid PVC compound used in the present invention to form the overlay can also include, but is not limited to, pigments, impact modifiers, stabilizers, processing aids, lubricants, fillers, other conventional additives, and the like.

The thermoplastic polymer compound to be processed can be in powder, liquid, cubed, pelletized form and/or any other extrudable form. Also, the thermoplastic polymer can be virgin, recycled, or a mixture of both. Furthermore, the thermoplastic material can be incorporated with a blowing agent or a mechanically injected gas during the extrusion process to make a cellular foam structure core.

The thermoplastic material used to form the core, which is preferably polyvinyl chloride, is preferably a suspension grade or mass polymerization grade homopolymer resin having a preferred molecular weight as reflected by an inherent viscosity of from about 0.88 to about 1.0 inherent Viscosity. In general, a higher molecular weight polymer is preferred from the standpoint of processing stability and preferably the molecular weight distribution and particle size distribution are narrow in order to provide a good balance between processability and properties. Also, high porosity

The two sections 12a and 12b each have an end portion 18a and 18b respectively, which is constructed of plastic or polycarbonate and is mounted to the free ends 20a and 20b of the two sections of particle board 12a and 12b by any means such as screws 19a and 19b. It is within the terms of the present invention to mount the free ends 20a and 20b to the two sections of particle board 12a and 12b by an adhesive such as glue.

Glue is a type of adhesive that has been used for centuries to bond various materials together. It is a sticky substance that hardens when it dries, creating a strong and permanent bond. The chemical composition of glue can vary depending on the type, but it is typically made up of natural or synthetic polymers, solvents, and other additives. The type of polymer used in the glue determines its strength, flexibility, and drying time.

The types of glue include epoxy, polyurethane, polyvinyl acetate, cyanoacrylate, contact cement and hot melt. It's also within the terms of the invention to use an adhesive. An adhesive is a bonding material that joins or sticks two different materials together. It is a versatile material that is widely used in different industries such as construction, automotive, and textile among others. Adhesives are composed of different chemicals that have unique properties to make it an effective bonding agent. The different types of adhesive include epoxy (two-part resin/hardener), polyurethane (prepolymer and curative), silicone (silicone resin and hardener), cyanoacrylate (ethyl cyanoacrylate and methyl cyanoacrylate), and acrylic (acrylic polymer and hardener). The type of polymer used in the glue determines its strength, flexibility, and drying time.

The first end portion 18a has a first side 20a which includes a first wall portion 22a that rests against the free end of section 12a of the particle board 12a. Both the first wall portion 22a and the free end section 12a of the first wall portion 22a are preferably flat and are able to rest against each other.

The second end portion 18b has a first side 20b which includes a first wall portion 22b that rests against the free end of section 12b of the particle board 12b. Both the first wall portion 22b and the free end section 12b of the second end portion 18b are preferably flat and are able to rest against each other.

The first end portion 18a has a second surface 24a which extends in a perpendicular direction from the first side 20a and rests against the bottom facing surface 2a of the particle board 12a so that the particle board 12a is securely mounted to the first end portion 18a.

The second end portion 18b has a second surface 24b which extends in a perpendicular direction from the first side 20b and rests against the bottom facing surface 2a of the particle board 12b so that the particle board 12b is securely mounted to the second end portion 12b.

Each of the end portions 18a and 18b also has a surface 24a and 24b, respectively, that rests against the lower surface 26a and 26b of the end of sections 12a and 12b of the particle boards.

Each of the end portions 18a and 18b are adapted to be secured to the first and second end portions 18a and 18b, respectively, by any desired means such as an adhesive or glue, as described herein above or by means of a screw 19a or 19b, respectively, as shown in FIG. 1.

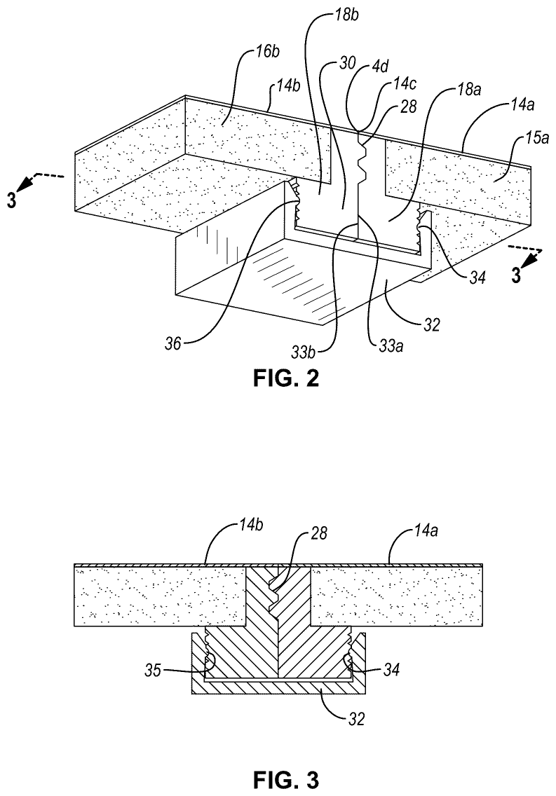

When the table 10 is assembled, the first and second end portions 18a and 18b rest against each other, as shown in FIGS. 2 and 3 to form an intersection line 28 so that the facing edges 14c and 14d of the laminate 14a and 14b abut one another and prevent or reduce the likelihood of liquid from collecting on the two sections of particle board 12a and 12b.

The outer facing surfaces 33a and 33b of the end portions 18a and 18b facing have a tongue and groove interconnection 30, as shown in FIG. 2. When the end portions 18a and 18b are interconnected, water, such as from washing the outer facing surface 14a and 14b of the table or structure 10 is at least partially prevented from leaking into the intersection line 28 so that liquid is at least partially prevented from collecting on the two sections of particle board 12a and 12b.

Each of the end portions 18a and 18b have a surface 36a and 36b, respectively, with a plurality of adjacent grooves extend the width of the end portions 18a and 18b. The plurality of adjacent grooves engage the ribs 34 and 35 extending the width of the connector 32. The is allows the clamp or connector to quickly secure or separate from the ribs 34 and 35 extending the width of the connector 32. When the connector, such as a U-shaped clamp 32, is attached to the two sections 12a and 12b, as shown in FIGS. 2 and 3, the end portions 18a and 18b are pressed against each other and the table is solidly interconnected.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A structure of two sections of particle board each having a top surface respectively, constructed of a laminate sheet of a material such as plastic or polycarbonate affixed to the top surface of the two sections;
the two sections each having an end portion mounted to the free ends of the two sections.

2. The structure of claim 1 wherein the two sections are constructed of particle board.

3. The structure of claim 2 wherein the two sections have end portions which are mounted to the free ends of the two sections of particle board.

4. The structure of claim 3 wherein the two sections have plastic or polycarbonate end portions which are removably mounted to the free ends of the two sections of particle board.

5. The structure of claim 4 wherein the two sections have plastic or polycarbonate end portions which are removably mounted to the free ends of the two sections of particle board by means such as screws.

6. The structure of claim 4 wherein one section has a plastic or polycarbonate end portions having a first side which includes a first wall portion that rests against the free end section of the first particle board.

7. The structure of claim 6 wherein one of the sections of particle board has a plastic or polycarbonate end portion having a first side which includes a first wall portion that rests against the free end of the one section of the first particle board.

8. The structure of claim 7 wherein another of the sections of particle board has a plastic or polycarbonate end portion having a first side which includes a second wall portion that rests against the free end of another of the sections of the first particle board.

9. The structure of claim 8 wherein each of the end portions has a surface that rests against a lower surface of the end of sections of the particle boards.

10. The structure of claim 9 wherein each of the end portions rests against each other to form an intersection line.

11. The structure of claim 10 wherein each of the end portions rests against each other to form an intersection line so that facing edges abut one another and reduces liquid from collecting on the two sections of particle board.

12. The structure of claim 11 wherein each of the end portions has an outer facing surface forming a tongue and groove interconnection.

13. The structure of claim 1 wherein each of the end portions has a surface with a plurality of adjacent grooves that engage ribs extending the width of a removable clamp.

14. The structure of claim 13 wherein the removable clamp is U-shaped and can be quickly secured to the ribs extending the width of a removable clamp.

15. The structure of claim 14 wherein the U-shaped clamp is attached to the two sections so that the end portions are securely interconnected.

16. The structure of claim 1 wherein the top surface is constructed of a laminate sheet of a plastic or polycarbonate material affixed to the top surface of the two sections.

17. The structure of claim 16 wherein the top surface is constructed of a laminate sheet of a plastic or polycarbonate material affixed to the top surface of the two sections by glue or PVC.

18. A structure of two sections of particle board each having a top surface respectively, constructed of a laminate sheet of a material such as plastic or polycarbonate affixed to the top surface of the two sections;
the two sections each having an end portion removably mounted to the free ends of the two sections of particle board;
wherein one section of particle board has a plastic or polycarbonate end portions having a first side which includes a first wall portion that rests against the free end of section of the first particle board; and
another of the sections of particle board has a plastic or polycarbonate end portion having a first side which includes a second wall portion that rests against the free end of the another of the sections of the second particle boards.

19. The structure of two sections of particle board of claim 18 wherein each of the end portions has an outer facing surface forming a tongue and groove interconnection whereby when the end portions are interconnected, liquid from the top surface of the structure is prevented from leaking into the intersection line formed between the end portions resting against each other so that liquid is prevented from collecting on the two sections of particle board.

20. The structure of two sections of particle board of claim 19 wherein each of the end portions has a surface with a plurality of adjacent grooves that engage ribs extending the width of a U-shaped clamp wherein the U-shaped clamp can be quickly attached or disconnected from the two sections.
